(19) United States
(12) Patent Application Publication
(10) Pub. No.: US 2026/0086245 A1
(43) Pub. Date: Mar. 26, 2026

(54) INTERFERENCE TESTING DEVICE, METHOD, AND SYSTEM

(71) Applicant: Kymeta Corporation, Redmond, WA (US)

(72) Inventor: David Lamme, Covington, WA (US)

(21) Appl. No.: 19/335,550

(22) Filed: Sep. 22, 2025

Related U.S. Application Data
(60) Provisional application No. 63/698,266, filed on Sep. 24, 2024.

(51) Int. Cl. G01S 19/21; G01S 19/23; G01S 19/27

(52) U.S. Cl. CPC G01S 19/21; G01S 19/23; G01S 19/27

(57) ABSTRACT

Methods and apparatuses for interference testing are disclosed. In some embodiments, an interference testing system includes a satellite antenna including an antenna control unit having a processor to perform satellite pointing and tracking. The interference testing system also includes a tracking command device operable to generate and communicate a signal to the tracking software, where the signal includes satellite pointing and tracking information to the tracking software. The tracking software is operable to use pointing and tracking information from a GNSS device and position information to scan for and detect satellites and signals communicated therethrough, and the tracking command device includes a modulator to generate one or more radio-frequency (RF) signals for an interference purpose using a detected satellite that is being tracked.

### RELATED APPLICATION

The present application is a non-provisional application of and claims the benefit of U.S. Provisional Patent Application No. 63/698,266, filed Sep. 24, 2024, and entitled “INTERFERENCE TESTING DEVICE, METHOD, AND SYSTEM”, which is incorporated by reference in its entirety.

### FIELD OF THE DISCLOSURE

Embodiments disclosed herein are related generally to signal interference testing, and in particular, to devices, software, methods, and systems to provide radio frequency (RF) surveys of satellites and constellations, and signal interference test signals using electronically scanned array antennas, for example, a metasurface-based electronically scanned array.

### BACKGROUND

Space combat power projection (CPP), space domain awareness (SDA), and information mobility represent some of the core areas of defense related activities. However, the landscape of space has changed rapidly, and legacy systems may no longer be sufficiently effective to facilitate accurate and comprehensive coverage, and rapid response to threats or adverse communications.

Satellite communications technologies were stagnant through the early 2000s. Most communications satellites were large geostationary (GEO) satellites, and their service area was often as wide as a continent. Legacy combat power projection (CCP) and radio frequency space domain awareness (SDA) systems were designed and fielded under this paradigm. A large system could be deployed to a friendly location and provide RF surveys and signals interference testing without having to enter a contested geographic territory. High throughput satellites with geographically smaller spot beams narrowed the satellite's footprint on the earth rendering legacy systems unable to perform their tasks in many cases as they could not be transported into the spot beams. Such systems must be able to enter the spot beam to provide RF surveys and interference testing. Recent introduction of Low Earth Orbit (LEO) constellations offers even smaller footprints within which to operate. However, such small footprints or coverage areas introduce an even more challenging environment with respect to size, weight, power (SWaP), and mobility during operations.

### SUMMARY

Methods and apparatuses for interference testing are disclosed. In some embodiments, an interference testing system includes a satellite antenna including an antenna control unit having a processor and a non-transitory computer-readable medium storing a tracking software with instructions that, when executed by the processor, cause the processor to perform satellite pointing and tracking. The interference testing system also includes a tracking command device in electronic communication with the tracking software and operable to generate and communicate a signal to the tracking software, where the signal includes satellite pointing and tracking information to the tracking software. The interference testing system further includes a global navigation satellite system (“GNSS”) device in electronic communication with the tracking software and operable to communicate position information to the tracking software. The tracking software is operable to use the pointing and tracking information and position information to scan for and detect satellites and signals communicated therethrough, and the tracking command device includes a modulator to generate one or more radio-frequency (RF) signals for an interference purpose using a detected satellite that is being tracked.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an exploded isometric view of a satellite antenna according to some embodiments.

FIG. 2 illustrates a schematic view of a satellite communication system according to some embodiments.

FIG. 3A illustrates an isometric view of an interference testing system according to some embodiments.

FIG. 3B illustrates a schematic view of an interference testing system according to some embodiments.

FIG. 4 illustrates some embodiments of a process for interference testing.

FIG. 5 illustrates some other embodiments of a process for interference testing.

FIG. 6 illustrates yet some other embodiments of a process for interference testing.

FIG. 7 illustrates examples of tracking command device and corresponding pointing and tracking information according to some embodiments.

### DETAILED DESCRIPTION

In the following description, numerous details are set forth to provide a more thorough explanation of embodiments of the present disclosure. It will be apparent, however, to one skilled in the art, that the teachings disclosed herein may be practiced without these specific details. In other instances, well-known structures and devices are shown in block diagram form, rather than in detail, in order to avoid obscuring the present disclosure.

Methods and apparatuses for interference testing are disclosed. In some embodiments, these methods and apparatuses are performed using a satellite antenna that is part of a satellite terminal. In some embodiments, the satellite antenna is an electronically scanned array (“ESA”). The interference testing can be performed using a tracking command device that operates in conjunction with software of the satellite antenna (e.g., ESA) to perform acquisition and tracking of objects or equipment, such as satellites. The tracking command device 304 is configured or operable to communicate acquisition and/or tracking information to the software of the satellite antenna, which in turn can control the scanning, acquisition, and tracking behavior via an antenna control unit.

### Examples of Antenna Embodiments

The techniques described herein may be used with a variety of flat panel satellite antennas. Some embodiments of such flat panel antennas are disclosed herein. In some embodiments, the flat panel satellite antennas are part of a satellite terminal. The flat panel antennas include one or more arrays of antenna elements on an antenna aperture.

In some embodiments, the antenna aperture is a metasurface antenna aperture, such as, for example, the antenna apertures described below. In some embodiments, the antenna elements comprise radio-frequency (RF) radiating antenna elements. In some embodiments, the antenna elements include tunable devices to tune the antenna elements. Examples of such tunable devices include diodes and varactors such as, for example, described in U.S. Pat. No. 11,489,266, entitled “Metasurface Antennas Manufactured with Mass Transfer Technologies,” issued Nov. 1, 2022. In some other embodiments, the antenna elements comprise liquid crystal (LC)-based antenna elements, such as, for example, those disclosed in U.S. Pat. No. 9,887,456, entitled “Dynamic Polarization and Coupling Control from a Steerable Cylindrically Fed Holographic Antenna”, issued Feb. 6, 2018, or other RF radiating antenna elements. It should be appreciated that other tunable devices such as, for example, but not limited to, tunable capacitors, tunable capacitance dies, packaged dies, micro-electromechanical systems (MEMS) devices, or other tunable capacitance devices, could be placed into an antenna aperture or elsewhere in variations on the embodiments described herein.

Although embodiments in this disclosure may draw on some examples in communications, some embodiments could be implemented in various receiving, transmitting, and/or sensing or other similar applications. Some examples could include devices for radar, lidar, sensors and sensing device such as, but not limited to, those in autonomous vehicles applications, and any other applications that can take advantage of attributes of an active metasurface according to various disclosed and undisclosed embodiments of the present disclosure.

In some embodiments, the antenna aperture having the one or more arrays of antenna elements is comprised of multiple segments that are coupled together. In some embodiments, when coupled together, the combination of the segments form groups of antenna elements (e.g., closed rings of antenna elements concentric with respect to the antenna feed, etc.). For more information on antenna segments, see U.S. Pat. No. 9,887,455, entitled “Aperture Segmentation of a Cylindrical Feed Antenna”, issued Feb. 6, 2018.

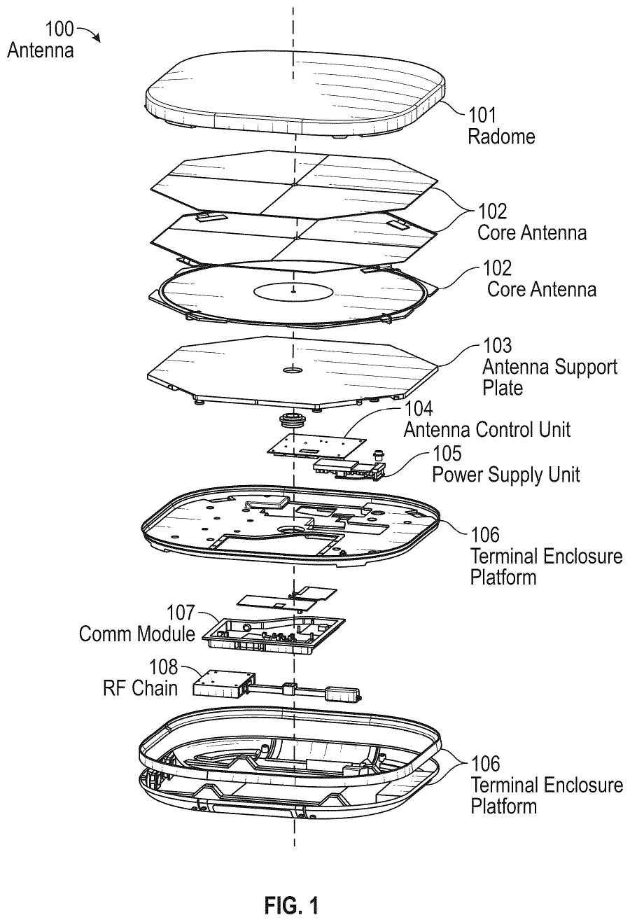

FIG. 1 illustrates an exploded view of some embodiments of a flat-panel antenna. Referring to FIG. 1, antenna 100 comprises a radome 101, a core antenna 102, antenna support plate 103, antenna control unit (ACU) 104, a power supply unit 105, terminal enclosure platform 106, comm (communication) module 107, and RF chain 108.

Radome 101 is the top portion of an enclosure that encloses core antenna 102. In some embodiments, radome 101 is weatherproof and is constructed of material transparent to radio waves to enable beams generated by core antenna 102 to extend to the exterior of radome 101.

In some embodiments, core antenna 102 comprises an aperture having RF radiating antenna elements. These antenna elements act as radiators (or slot radiators). In some embodiments, the antenna elements comprise scattering metamaterial antenna elements. In some embodiments, the antenna elements comprise both Receive (Rx) and Transmit (Tx) irises, or slots, that are interleaved and distributed on the whole surface of the antenna aperture of core antenna 102. Such Rx and Tx irises may be in groups of two or more sets where each set is for a separately and simultaneously controlled band. Examples of such antenna elements with irises are described in U.S. Pat. No. 10,892,553, entitled “Broad Tunable Bandwidth Radial Line Slot Antenna”, issued Jan. 12, 2021.

In some embodiments, the antenna elements comprise irises (iris openings) and the aperture antenna is used to generate a main beam shaped by using excitation from a cylindrical feed wave for radiating the iris openings through tunable elements (e.g., diodes, varactors, patch, etc.). In some embodiments, the antenna elements can be excited to radiate a horizontally or vertically polarized electric field at desired scan angles.

In some embodiments, a tunable element (e.g., diode, varactor, patch etc.) is located over each iris slot. The amount of radiated power from each antenna element is controlled by applying a voltage to the tunable element using a controller in ACU 104. Traces in core antenna 102 to each tunable element are used to provide the voltage to the tunable element. The voltage tunes or detunes the capacitance and thus the resonance frequency of individual elements to effectuate beam forming. The voltage required is dependent on the tunable element in use. Using this property, in some embodiments, the tunable element (e.g., diode, varactor, LC, etc.) integrates an on/off switch for the transmission of energy from a feed wave to the antenna element. When switched on, an antenna element emits an electromagnetic wave like an electrically small dipole antenna. Note that the teachings herein are not limited to having unit cell that operates in a binary fashion with respect to energy transmission. For example, in some embodiments in which varactors are the tunable element, there are 32 tuning levels. As another example, in some embodiments in which LC is the tunable element, there are 16 tuning levels.

A voltage between the tunable element and the slot can be modulated to tune the antenna element (e.g., the tunable resonator/slot). Adjusting the voltage varies the capacitance of a slot (e.g., the tunable resonator/slot). Accordingly, the reactance of a slot (e.g., the tunable resonator/slot) can be varied by changing the capacitance. Resonant frequency of the slot also changes according to the equation

$$f = \frac{1}{2 π \sqrt{LC}}$$

where f is the resonant frequency of the slot and L and C are the inductance and capacitance of the slot, respectively. The resonant frequency of the slot affects the energy coupled from a feed wave propagating through the waveguide to the antenna elements.

In particular, the generation of a focused beam by the metamaterial array of antenna elements can be explained by the phenomenon of constructive and destructive interference, which is well known in the art. Individual electromagnetic waves sum up (constructive interference) if they have the same phase when they meet in free space to create a beam, and waves cancel each other (destructive interference) if they are in opposite phase when they meet in free space. If the slots in core antenna 102 are positioned so that each successive slot is positioned at a different distance from the excitation point of the feed wave, the scattered wave from that antenna element will have a different phase than the scattered wave of the previous slot. In some embodiments, if the slots are spaced one quarter of a wavelength apart, each slot will scatter a wave with a one fourth phase delay from the previous slot. In some embodiments, by controlling which antenna elements are turned on or off (i.e., by changing the pattern of which antenna elements are turned on and which antenna elements are turned off) or which of the multiple tuning levels is used, a different pattern of constructive and destructive interference can be produced, and the antenna can change the direction of its beam(s).

In some embodiments, core antenna 102 includes a coaxial feed that is used to provide a cylindrical wave feed via an input feed, such as, for example, described in U.S. Pat. No. 9,887,456, entitled “Dynamic Polarization and Coupling Control from a Steerable Cylindrically Fed Holographic Antenna”, issued Feb. 6, 2018 or in U.S. Pat. No. 11,489,266, entitled “Metasurface Antennas Manufactured with Mass Transfer Technologies,” issued Nov. 1, 2022. In some embodiments, the cylindrical feed wave feeds core antenna 102 from a central point with an excitation that spreads outward in a cylindrical manner from the feed point. In other words, the cylindrically fed wave is an outward travelling concentric feed wave. Even so, the shape of the cylindrical feed antenna around the cylindrical feed can be circular, square or any shape. In some other embodiments, a cylindrically fed antenna aperture creates an inward travelling feed wave. In such a case, the feed wave most naturally comes from a circular structure.

In some embodiments, the core antenna comprises multiple layers. These layers include the one or more substrate layers forming the RF radiating antenna elements. In some embodiments, these layers may also include impedance matching layers (e.g., a (WAIM) layer, etc.), one or more spacer layers and/or dielectric layers. Such layers are well-known in the art.

Antenna support plate 103 is coupled to core antenna 102 to provide support for core antenna 102. In some embodiments, antenna support plate 103 includes one or more waveguides and one or more antenna feeds to provide one or more feed waves to core antenna 102 for use by antenna elements of core antenna 102 to generate one or more beams.

ACU 104 is coupled to antenna support plate 103 and provides controls for antenna 100. In some embodiments, these controls include controls for drive electronics for antenna 100 and a matrix drive circuitry to control a switching array interspersed throughout the array of RF radiating antenna elements. In some embodiments, the matrix drive circuitry uses unique addresses to apply voltages onto the tunable elements of the antenna elements to drive each antenna element separately from the other antenna elements. In some embodiments, the drive electronics for ACU 104 comprise commercial off-the shelf LCD controls used in commercial television appliances that adjust the voltage for each antenna element.

More specifically, in some embodiments, ACU 104 supplies an array of voltage signals to the tunable devices of the antenna elements to create a modulation, or control, pattern. The control pattern causes the elements to be tuned to different states. In some embodiments, ACU 104 uses the control pattern to control which antenna elements are turned on or off (or which of the tuning levels is used) and at which phase and amplitude level at the frequency of operation. The elements are selectively detuned for frequency operation by voltage application. In some embodiments, multistate control is used in which various elements are turned on and off to varying levels, further approximating a sinusoidal control pattern, as opposed to a square wave (i.e., a sinusoid gray shade modulation pattern).

In some embodiments, ACU 104 also contains one or more processors executing the software to perform some of the control operations. ACU 104 may control one or more sensors (e.g., a GPS receiver, a three-axis compass, a 3-axis accelerometer, 3-axis gyro, 3-axis magnetometer, etc.) to provide location and orientation information to the processor(s). The location and orientation information may be provided to the processor(s) by other systems in the earth station and/or may not be part of the antenna system.

Antenna 100 also includes a comm (communication) module 107 and an RF chain 108. Comm module 107 includes one or more modems enabling antenna 100 to communicate with various satellites and/or cellular systems, in addition to a router that selects the appropriate network route based on metrics (e.g., quality of service (QoS) metrics, e.g., signal strength, latency, etc.). RF chain 108 converts analog RF signals to digital form. In some embodiments, RF chain 108 comprises electronic components that may include amplifiers, filters, mixers, attenuators, and detectors.

Antenna 100 also includes power supply unit 105 to provide power to various subsystems or parts of antenna 100.

Antenna 100 also includes terminal enclosure platform 106 that forms the enclosure for the bottom of antenna 100. In some embodiments, terminal enclosure platform 106 comprises multiple parts that are coupled to other parts of antenna 100, including radome 101, to enclose core antenna 102.

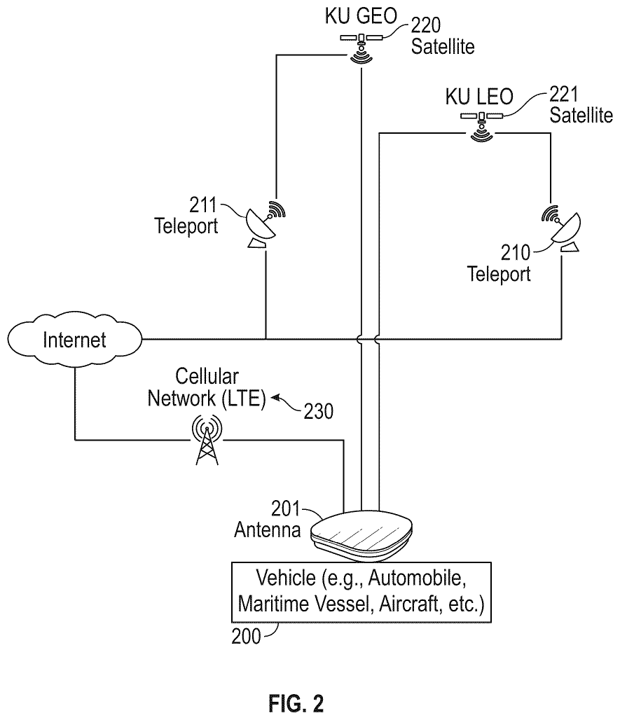

FIG. 2 illustrates an example of a communication system that includes one or more antennas described herein. Referring to FIG. 2, vehicle 200 includes an antenna 201. In some embodiments, antenna 201 comprises antenna 100 of FIG. 1. In some embodiments, vehicle 200 may comprise any one of several vehicles, such as, for example, but not limited to, an automobile (e.g., car, truck, bus, etc.), a maritime vehicle (e.g., boat, ship, etc.), airplanes (e.g., passenger jets, military jets, small craft planes, etc.), etc. Antenna 201 may be used to communicate while vehicle 200 is either on-the-pause or moving. Antenna 201 may be used to communicate to fixed locations as well, e.g., remote industrial sites (mining, oil, and gas) and/or remote renewable energy sites (solar farms, windfarms, etc.).

In some embodiments, antenna 201 is able to communicate with one or more communication infrastructures (e.g., satellite, cellular, networks (e.g., the Internet), etc.). For example, in some embodiments, antenna 201 is able to communication with satellites 220 (e.g., a GEO satellite) and 221 (e.g., a LEO satellite), cellular network 230 (e.g., an LTE network, etc.), as well as network infrastructures (e.g., edge routers, Internet, etc.). For example, in some embodiments, antenna 201 comprises one or more satellite modems (e.g., a GEO modem, a LEO modem, etc.) to enable communication with various satellites such as satellite 220 (e.g., a GEO satellite) and satellite 221 (e.g., a LEO satellite) and one or more cellular modems to communicate with cellular network 230. For another example of an antenna communicating with one or more communication infrastructures, see U.S. Pat. No. 11,818,606, entitled “Multiple Aspects of Communication in a Diverse Communication Network”, and issued Nov. 14, 2023. Communication between a network, such as for example, the Internet and satellites 220 and 221 can be via teleports 211 and 210, respectively.

In some embodiments, to facilitate communication with various satellites, antenna 201 performs dynamic beam steering. In such a case, antenna 201 is able to dynamically change the direction of a beam that it generates to facilitate communication with different satellites. In some embodiments, antenna 201 includes multi-beam beam steering that allows antenna 201 to generate two or more beams at the same time, thereby enabling antenna 201 to communication with more than one satellite at the same time. Such functionality is often used when switching between satellites (e.g., performing a handover). For example, in some embodiments, antenna 201 generates and uses a first beam for communicating with satellite 220 and generates a second beam simultaneously to establish communication with satellite 221. After establishing communication with satellite 221, antenna 201 stops generating the first beam to end communication with satellite 220 while switching over to communicate with satellite 221 using the second beam. For more information on multi-beam communication, see U.S. Pat. No. 11,063,661, entitled “Beam Splitting Hand Off Systems Architecture”, issued Jul. 13, 2021.

In some embodiments, antenna 201 uses path diversity to enable a communication session that is occurring with one communication path (e.g., satellite, cellular, etc.) to continue during and after a handover with another communication path (e.g., a different satellite, a different cellular system, etc.). For example, if antenna 201 is in communication with satellite 220 and switches to satellite 221 by dynamically changing its beam direction, its session with satellite 220 is combined with the session occurring with satellite 221.

In some embodiments, antenna 201 is composed of one or more antennas operating as a single antenna communicating with a single satellite, or multiple antennas operating with multiple satellites simultaneously. For example, antenna 201 could be composed of four antennae in communication with satellite 220, or with two antennae simultaneously in communication with satellite 220 and two antennae in communication with satellite 221.

Thus, the antennas described herein may be part of a satellite terminal that enables ubiquitous communications and multiple different communication connections. In some embodiments, antenna 201 comprises a metasurface RF antenna having multiple RF radiating antenna elements that are tuned to desired frequencies using RF antenna element drive circuitry. The drive circuitry can include a drive transistor (e.g., a thin film transistor (TFT) (e.g., CMOS, NMOS, etc.), low or high temperature polysilicon transistor, memristor, etc.), a Microelectromechanical systems (MEMS) circuit, or other circuit for driving a voltage to an RF radiating antenna element. In some embodiments, the drive circuitry comprises an active-matrix drive. In some embodiments, the frequency of each antenna element is controlled by an applied voltage. In some embodiments, this applied voltage is also stored in each antenna element (pixel circuit) until the next voltage writing cycle.

### Interference Testing Device, Method, and System

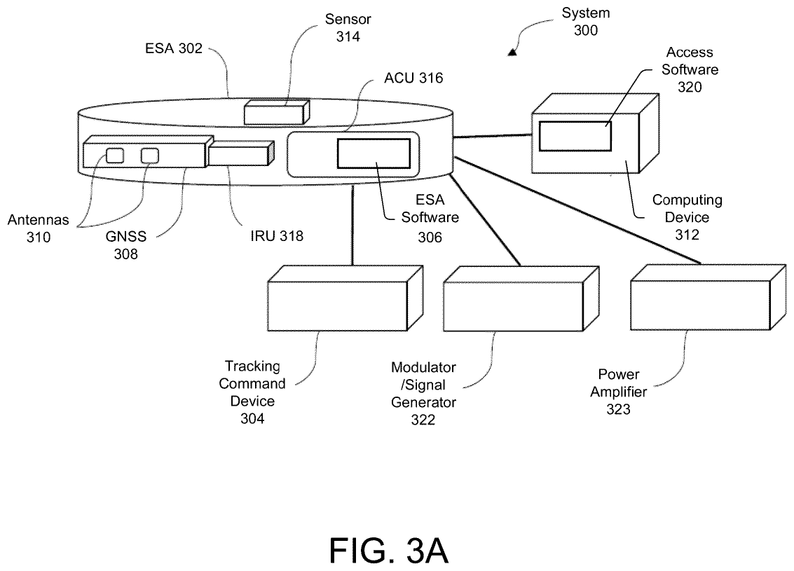

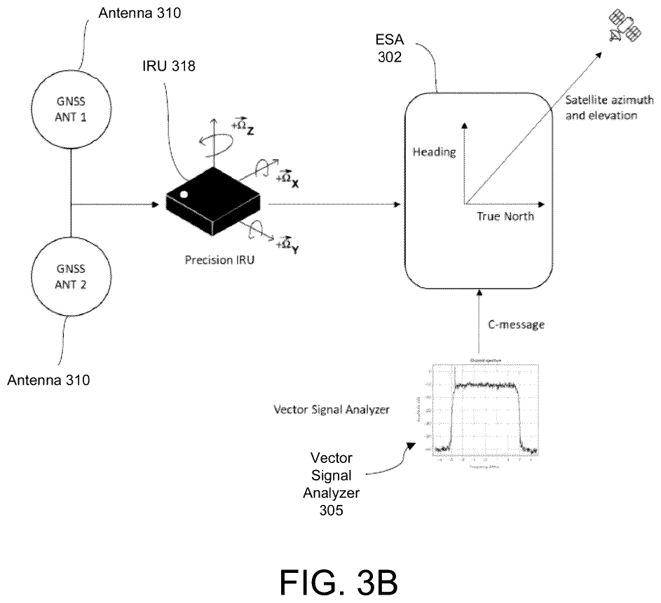

Referring to FIG. 3A, some embodiments of the present disclosure can include a system 300 including an electronically scanned array (“ESA”) 302, a tracking command device 304, and an algorithm or software 306 with a set of instructions, which can be stored on a tangible medium such as computer readable medium, for example, a non-transitory computer-readable medium, and when executed by a processor causes the processor to perform acquisition and tracking of objects or equipment, such as satellites. In some embodiments, the ESA 302 includes an antenna control unit (“ACU”) 316 that can serve as the medium and processor from which the ESA software 306 can be operated and/or on which it is installed and is executed. The tracking command device 304 is configured or operable to communicate acquisition and/or tracking information to the ESA software 306, which in turn can control the ESA 302 scanning, acquisition, and tracking behavior via the ACU 316.

In some embodiments, the system 300 can include a global navigation satellite system (“GNSS”) 308, for example an inertial aided dual GNSS, with antennas 310 selectively positioned at locations with respect to the ESA 302, for example at known fixed locations on a face of the ESA 302. The ESA 302 can be equipped with, coupled to, and/or in electronic communication with the GNSS 308. Other GNSS devices are contemplated to be within the scope of the present disclosure, to inform a position of the ESA 302 and true north, providing a frame of reference to begin applying the acquisition and/or tracking information to acquire or track satellites.

In some embodiments, the GNSS 308 can include, or be coupled to or in electronic communication with an inertial reference unit (“IRU”) 318 such as a precision IRU that can provide rapid and accurate acceleration information at least about one axis. In some embodiments, the IRU 318 provides acceleration information about three axes as schematically shown in FIG. 3B. In some embodiments, the GNSS 308 and IRU 318 provide and/or electronically communicate substantially precise location and true north information to the ESA ACU 316. In some embodiments, the ACU of the ESA 302 combines the data from the IRU 318 with the GNSS position to determine location, orientation and heading. In some embodiments, the GNSS 308 can be operable or configured to provide an accurate heading without requiring the ESA 302 to be in motion. The IRU 318 can be configured or operable to measure and communicate to the ESA software 306, motion characteristics when the ESA 302 is in motion. The ESA software 306 in some embodiments then uses the location of the ESA 302 and motion information when applying the acquisition and/or tracking information to scan and acquire or track satellites. More specifically, in some embodiments, the ESA 302 uses the combined information to understand the ESA's position, orientation, and heading in order to make a mathematical transformation of the beam pattern to the ESA 302.

In some embodiments, the tracking command device 304 can include a first vector signal analyzer 305 (FIG. 3B) operable to generate, provide, and/or send a signal, such as but not limited to, C-message traffic under the open antenna to modem interface protocol standard “OpenAMIP”, to the ESA software 306 being operable to enable acquisition and tracking behavior of the ESA 302, such as two-line element (“TLE”) acquisition and tracking of satellites and satellite constellations.

In some embodiments, the signal could include a C-message in some applications depending on the vector signal analyzer to antenna protocols. TLE acquisition and tracking of satellites involves obtaining and updating the orbital parameters of satellites using TLE data. Updating such parameters can be substantially continuous in some embodiments. TLE data is a standard format used to convey sets of orbital elements that describe the trajectory of an Earth-orbiting object, such as a satellite or space debris.

In some embodiments, the signal that the tracking command device 304 sends when operating can include a test signal. In some embodiments, this test signal can include C-message traffic. In some embodiments, the test signal can be for testing a part of a link (e.g., uplink, downlink, or both) for interference. In some other embodiments, the test signal is for causing interference.

In some embodiments, the system 300 can include a computing device 312 for communicating acquisition and tracking information to the ESA 302. The computing device 312 can be configured to host access software or a computer-readable algorithm 320 operable to access public or private ephemeris libraries such as CelesTrak. In some embodiments, the access software 320 can be programmable or configured with user-provided ephemeris. According to some embodiments, the access software 320 can be in electronic communication or interfaces with the software 306 of the ESA 302 to provide initial pointing and tracking commands for a satellite or satellite constellation. Initial pointing and tracking information could include satellite longitude, receive center frequency, transmit center frequency, receive polarization, and transmit polarization. Given some satellites are in motion, such information provides location and motion data for the ESA 302 to track the satellite. The computing device 312 could in various embodiments be external to, or it can be integrated with or in, the ESA 302.

In some embodiments, the system 300 can include a sensor 314 for communicating acquisition and tracking information to the ESA 302. In some embodiments, the sensor 314 is a sensor external to the ESA 302, while in other embodiments, the sensor 314 is integrated with or in, the ESA 302. The access software 320 can be configured, or be in electronic communication with the sensor 314, to receive feedback or information from the sensor 314 to track a particular signal of interest. Such feedback can vary based on different applications and can in some cases include data and information. For example, in some embodiments, the access software 320 can be configured for TLE tracking and acquisition to point the ESA 302 to a satellite and observe all signal traffic end to end across the satellite's operating spectrum frequency. In some applications, where only particular signals are intended for collection, the access software 320 can be configured to be operable to characterize the specific signals and provide feedback to the ESA software 306 to control the ESA 302 to track the specific signals. The ephemeris provides a broad look at satellites and the computing device 312 can provide granular data based on the target satellite.

In some embodiments, the sensor 314 can include a vector signal analyzer with which a user highlights or presents the desired signal, and the system 300 can be configured, for example through the ESA software 306 to command the ESA 302 to maximize carrier-to-noise ratio (CNR) on that signal, for example. In some embodiments, this vector signal analyzer can be the tracking command device 304 described above, or it can be a distinct device or sensor. In some embodiments, the access software 320 interfaces with the system 300, for example with the ESA software 306, and provides signal or C-message metrics to the ESA (e.g., CNR and composite power). The signal or C-message metrics can promote or facilitate the system 300 to remain peaked on the signal while on the move (OTM) or at the halt (ATH). Also, such metrics can be used to determine impact of interference experienced on or imposed upon a link.

In some embodiments, ESA software 306 or access software 320 can also function in Skymap mode, in which it can scan the sky and create a map or other report, such as a heatmap, showing where the system 300 is observing a desired frequency. In basic Skymap mode, the ESA software 306 is provided with a center frequency and polarization. The ESA 302 then scans all satellites in its field of view and provides a heatmap of all satellites with a signal at that frequency. In some embodiments, the ESA software 306 or access software 320 can operate in an advanced mode enabling the user to provide information on the signal such as modulation and coding scheme, forward error correction, and symbol rate. In this mode, the ESA software 306 or access software 320 can be operable to scan all satellites within its field of view to identify signals with the designated characteristics. The ESA software 306 or access software 320 can be operable to report positives by satellite longitude, center frequency, and polarization. In certain applications, these features support detecting undesired/unauthorized signals and targeting and terminating the same.

In certain aspects, some embodiments could include enhancements such as higher output power amplifiers to increase maximum effective isotropic radiated power. Such enhancements may be required to achieve the desired effects of interference testing when the system intended to be affected by the testing includes antennas with significantly higher gain.

In some embodiments, the system 300 can include, integrate, be coupled to, and/or in electronic communication with, a power amplifier 323 such as a 100 W power amplifier capable of operating at 100% duty cycle without damaging an aperture of the ESA 302.

Some embodiments of the present disclosure can be used in applications involving phased array antennas in which case, the amplifier power 323 will be the effective input power or effective power to the flange because in the phased array application, the radiated power is distributed across the array.

In some embodiments, the system 300 can include, integrate, be coupled to, and/or in electronic communication with a modulator, signal generator, or other signal generating device 322 to present radio frequency signals on acquired and/or tracked satellites for communications and/or interference testing processes similar to those described herein.

Therefore, embodiments disclosed herein can improve fidelity of inertial-aided GNSS acquisition and tracking. Additionally, this acquisition and tracking method can enable the ESA terminal to be modem, network, and/or waveform agnostic. This can also enable other market demands and applications in which proprietary waveforms are used and eliminates significant development efforts to add new terminal configurations.

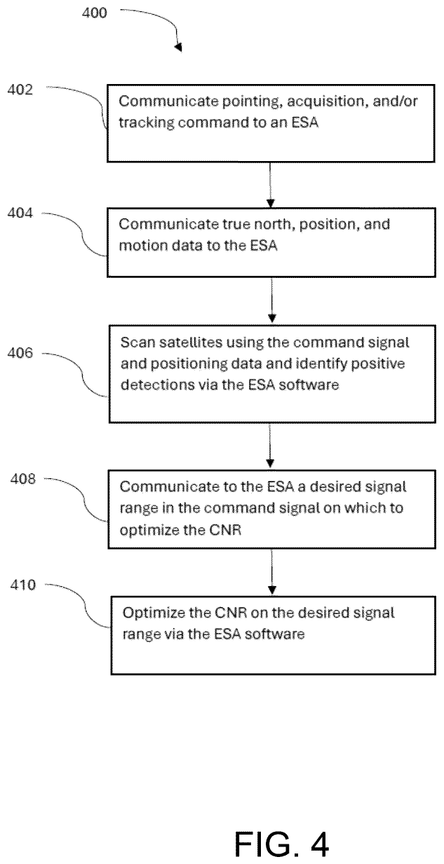

FIG. 4 illustrates some embodiments of a process for interference testing 400. In some embodiments, the process is implemented by processing logic comprising hardware (e.g., circuitry, dedicated logic, etc.), software (e.g., software running on a chip, software run on a general-purpose computer system or a dedicated machine, etc.), firmware, or a combination of the three. In some embodiments, the process is performed by a satellite terminal, such as, for example, the satellite terminal described above, that includes an array of antenna elements (e.g., a metasurface, an array of radio-frequency (RF) radiating elements, resonators, etc.), an antenna control unit (ACU), a computing engine/device, a modem, an IRU, and one or more receivers (e.g., one or more GNSS receivers) along with a tracking command device.

Referring to FIG. 4, the process 400 includes processing logic communicating a command signal from a command device to an ESA (processing block 402). In some embodiments, the command signal includes a pointing, acquisition, and/or tracking command. In some embodiments, the command signal is sent to an antenna that is other than an ESA.

The process also includes processing logic communicating positioning information to the ESA (processing block 404). In some embodiments, the positioning information includes indicating a heading of the ESA (or satellite terminal of which the ESA is part), an indication of true north, a position of the ESA (or its satellite terminal), and motion data including acceleration in one or more axis and position changes. In some embodiments, the heading of the ESA, the indication of true north, position of the ESA and motion data are from a GNSS device (with one or more GNSS receivers). In some embodiments, using the position and heading, the processing logic predicts the path of the ESA (or its satellite terminal). In some embodiments, the GNSS device includes an IRU, which provides acceleration information with respect to one or more axis (e.g., one axis, two axis, three axis) for the satellite antenna (or its satellite terminal) and the acceleration information is included as part of the motion data. With the GNSS, the system can determine velocity and a velocity vector based on the change in position over time while under motion. This also enables the system to determine true north and the system's heading relative to true north. In some embodiments, the IRU propagates the ephemeris for a desired satellite to the antenna control unit (ACU) in the ESA.

In some embodiments, the process 400 includes processing logic scanning for satellites using the command signal and positioning data via the ESA using its tracking software and identifying any positive detections of one or more satellites (processing block 406). In some embodiments, the tracking software performs the scanning using the command signal and positioning data that includes two-line-element (TLE) sets containing orbital ephemeris information along with the position information, the acceleration information, the heading information and the indication of true north. In some embodiments, the TLEs are transferred to, stored, and propagated in the ACU through an application programming interface (API). In some embodiments, the TLEs are stored and propagated on an external device and the external device commands ESA pointing angles through an API.

After identifying at least one positive detection, in some embodiments, the process 400 includes processing logic communicating a desired signal characteristics on which to improve, and potentially optimize, the carrier-to-noise ratio (CNR) to the ACU in the ESA (processing block 408) as a closed-loop feedback mechanism. In some embodiments, the processing logic communicating the desired signal characteristic is part of the command device and is included in a signal from a signal generating device in the command device to the ESA. This signal generating device could be a sensor or signal generating device separate from the command device in other embodiments. In response to receiving the desired signal characteristics, processing logic in the ESA improves, and potentially optimizes, the CNR on the specified signal characteristic (processing block 410). Thus, in some embodiments, by pointing at a satellite with the correct polarization, the system performs closed-loop tracking by identifying identifiable characteristics (e.g., bandwidth, modulation and coding, FEC, power, and/or other characteristics), and the tracking software will assign a value indicating a “lock” state, along with a CNR of the signal of interest, and this data is sent to the ACU and used to attempt to maintain the highest lock state and maximize the CNR.

After the ESA detects a satellite signal from a satellite (acquisition) and tracking of that satellite occurs, the tracking command device in cooperation with the ESA can be used to generate one or more RF signals for interference purposes. In some embodiments, the interference purpose comprises interference testing with respect to link between the satellite being tracked and the ESA (or other type of satellite antenna). In some embodiments, a modulator, signal generator, or other signal generating device presents the RF signals on acquired and/or tracked satellites for interference purposes, and the ESA enables generation of those signals at any frequency and any polarization. This can be through software control of the frequency and polarization by the ESA.

In some embodiments, to perform such interference testing, the ESA is configured to have a receive sub-array and a transmit sub-array, and further the interference testing is performed using communications being sent on the link from the transmit sub-array to the receive sub-array via the satellite. In other words, the pointing and tracking of the receive sub-array of the ESA are coupled with the transmit sub-array of the ESA. Such an arrangement allows for testing whether interference is happening on the uplink and/or the downlink and allows for testing to see resiliency of a waveform being used for communication on the link.

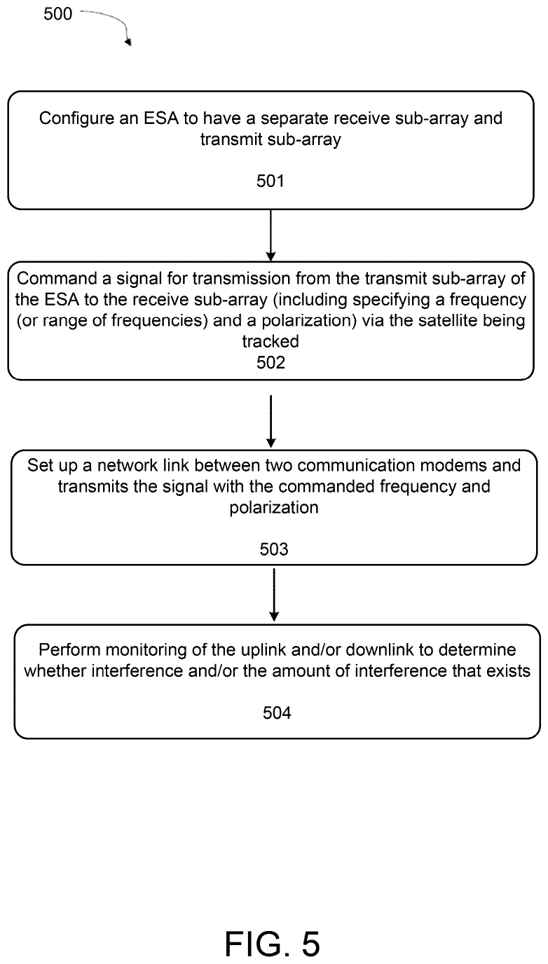

FIG. 5 illustrates some other embodiments of a process for interference testing 500. In some embodiments, the process is implemented by processing logic comprising hardware (e.g., circuitry, dedicated logic, etc.), software (e.g., software running on a chip, software run on a general-purpose computer system or a dedicated machine, etc.), firmware, or a combination of the three. In some embodiments, the process is performed by a satellite terminal, such as, for example, the satellite terminal described above, that includes an array of antenna elements (e.g., a metasurface, an array of RF radiating elements, resonators, etc.), an antenna control unit (ACU), a computing engine/device, a modem, an IRU, and one or more receivers (e.g., one or more GNSS receivers) along with a tracking command device.

Referring to FIG. 5, the process includes processing logic configuring an ESA to have a separate receive sub-array and transmit sub-array (processing block 501). Next processing logic commands a signal for transmission from the transmit sub-array of the ESA to the receive sub-array (including specifying a frequency (or range of frequencies) and a polarization) via a satellite being tracked to which the ESA is pointing (processing block 502). Processing logic sets up a network link between two communication modems and transmits the signal with the commanded frequency and polarization (processing block 503). Thereafter, processing performs monitoring of the uplink and/or downlink to determine whether interference and/or the amount of interference that exists (processing block 504).

In some other embodiments, the interference purpose comprises interference with communications of an existing link associated with the detected satellite using the signal transmitted by the satellite antenna to the detected satellite. In such a case, the tracking command device provides a signal with a frequency and polarization that match those of a signal being used for communications of the existing link associated with the detected satellite. Such a process can be used while performing pointing and tracking with respect to a satellite without any knowledge about the satellite other than its orbital properties (e.g., two-line element information) as long as it's in the correct frequency band and carriers on the signal. As with the above processes, a vector signal generator (or modem) on the transmit side can be used to present the RF frequency signals that match the signal already on the satellite for causing interference in the interference operation.

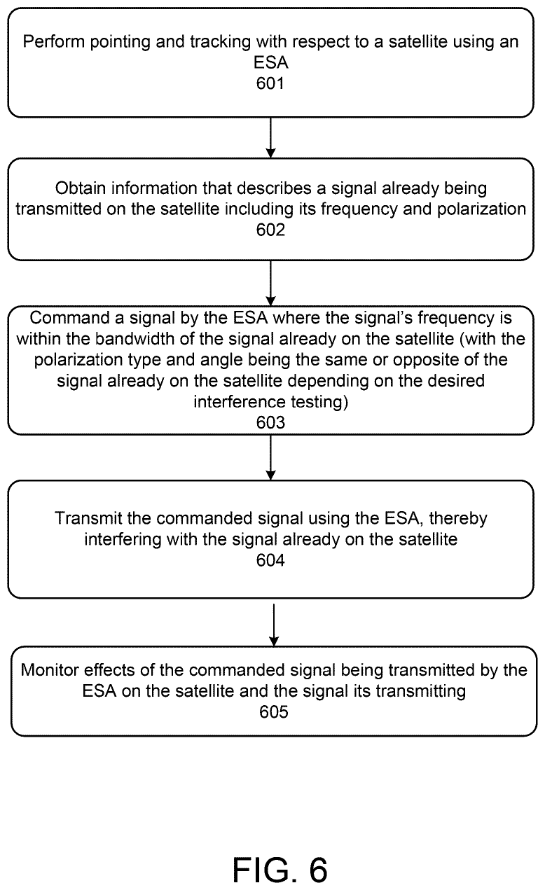

FIG. 6 illustrates yet some other embodiments of a process for interference testing. In some embodiments, the process is implemented by processing logic comprising hardware (e.g., circuitry, dedicated logic, etc.), software (e.g., software running on a chip, software run on a general-purpose computer system or a dedicated machine, etc.), firmware, or a combination of the three. In some embodiments, the process is performed by a satellite terminal, such as, for example, the satellite terminal described above, that includes an array of antenna elements (e.g., a metasurface, an array of RF radiating elements, resonators, etc.), an antenna control unit (ACU), a computing engine/device, a modem, an IRU, and one or more receivers (e.g., one or more GNSS receivers) along with a tracking command device.

Referring to FIG. 6, processing logic performs pointing and tracking with respect to a satellite using an ESA (processing block 601). The pointing and tracking can be performed as described herein. Processing logic obtains information that describes a signal already being transmitted on the satellite including its frequency and polarization (processing block 602). This determination can be made by locking onto the carriers of the satellite. In response to the determination, processing logic commands command a signal by the ESA where the signal's frequency is within the bandwidth of the signal already on the satellite (processing block 603). The polarization type and angle can be the same or opposite of the signal already on the satellite depending on the desired interference testing. Processing logic uses the ESA to transmit the commanded signal, thereby interfering with the signal already on the satellite (processing block 604). In some embodiments, the process also includes monitoring the effects of the commanded signal being transmitted by the ESA on the satellite and the signal its transmitting (processing block 605).

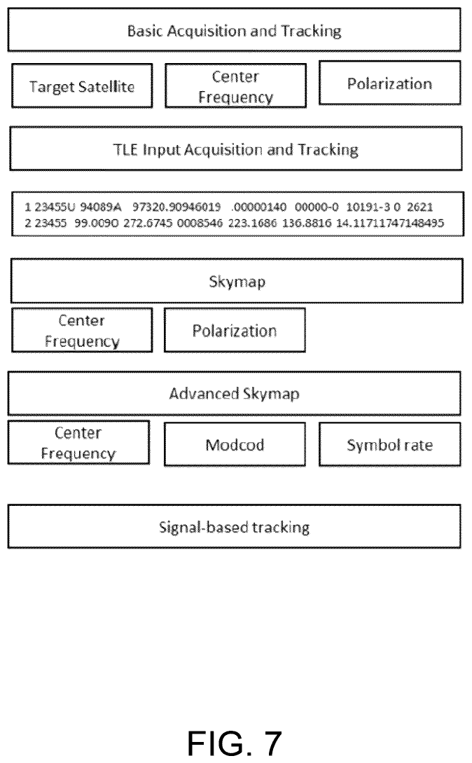

FIG. 7 schematically illustrates some examples of various acquisition and tracking command signal types and information included in the corresponding command signal. In some embodiments, these can be used individually or in some combinations. These signals have been described herein.

In various embodiments, the system or method could include an interface device which the ESA can communicate to display or otherwise provide the user with visual or other indication of satellite detection and/or signal detection.

Some embodiments of the present disclosure can provide SDA, CPP, and information mobility on a global scale in a mobile and low SWAP application. This is highly advantageous and desirable in defense related activities including those in the U.S. and allied governments. There could exist thousands of signals for which existing systems are unable to obtain information.

One example application can include detecting unwanted or adverse signals and eliminating or altering such signals to avoid their intended purpose.

In some embodiments of the present disclosure, the ESA can retain its operability as a communication terminal, while performing secondary and tertiary missions as described herein or that are within the scope of the present disclosure. For example, while a portion of the ESA is being used for communications with a satellite, a portion of the antenna array (e.g., a specific sub-array of the ESA antenna element array) can being used for separate transmit operations related to the interference purposes. Furthermore, some embodiments can be scalable to a multi-beam ESA where raw signals intelligence data can be transmitted live through a second beam on the ESA. Given an accurate pointing system as described, the ESA receive (Rx) aperture could perform the signals intelligence function on a given satellite while the transmit aperture independently points to another satellite and live-streams the data.

Embodiments can also enable a mobile and low SWaP system to perform the same or improved functionality as large legacy systems.

Some embodiments can include a demodulator or de-encryption devices operable to break down, de-encrypt, or parse an intercepted signal.

There is a number of example embodiments described herein.

Example 1 is an interference testing system comprising: a satellite antenna including an antenna control unit having a processor and a non-transitory computer-readable medium storing a tracking software with instructions that, when executed by the processor, cause the processor to perform satellite pointing and tracking; a tracking command device in electronic communication with the tracking software and operable to generate and communicate a signal to the tracking software, where the signal including satellite pointing and tracking information to the tracking software; and a global navigation satellite system (“GNSS”) device in electronic communication with the tracking software and operable to communicate position information to the tracking software, wherein the tracking software is operable to use the pointing and tracking information and position information to scan for and detect satellites and signals communicated therethrough. The tracking command device includes a modulator to generate one or more radio-frequency (RF) signals for an interference purpose using a detected satellite that is being tracked.

Example 2 is the system of example 1 that may optionally include that the satellite antenna is an electronically scanned array antenna.

Example 3 is the system of example 1 that may optionally include an inertial reference unit (IRU) in electronic communication or coupled with the GNSS device, the IRU operable to provide acceleration information at least about one of a plurality of axes.

Example 4 is the system of example 3 that may optionally include that the tracking software uses two-line-element sets and ephemeris information along with the position information, the acceleration information and heading information including an estimate of a heading of the satellite antenna to perform acquisition and tracking with respect to one or more of the satellites.

Example 5 is the system of example 1 that may optionally include that the interference purpose comprises interference testing with respect to link between the detected satellite and the satellite antenna.

Example 6 is the system of example 5 that may optionally include that the satellite antenna is an electronically scanned array antenna that is reconfigurable to have a receive sub-array and a transmit sub-array, and further wherein interference testing is performed using communications being sent on the link from the transmit sub-array to the receive sub-array.

Example 7 is the system of example 1 that may optionally include that the interference purpose comprises interference with communications of an existing link associated with the detected satellite using the signal transmitted by the satellite antenna to the detected satellite, the signal having a frequency and polarization that match a signal being used for communications of the existing link associated with the detected satellite.

Example 8 is the system of example 1 that may optionally include that the tracking command device includes a vector signal analyzer.

Example 9 is the system of example 1 that may optionally include that the tracking command device includes a sensor in electronic communication with an ephemeris database and operable to communicate satellite information from the ephemeris to the tracking software.

Example 10 is the system of example 1 that may optionally include a sensor or a vector signal analyzer operable to communicate a range in the pointing and tracking information to improve accuracy of the tracking software.

Example 11 is the system of example 1 that may optionally include an amplifier coupled to the satellite antenna.

Example 12 is an interference testing method comprising: communicating satellite pointing and tracking signal to a tracking software of a satellite antenna having an antenna control unit; communicating positioning and acceleration information to the tracking software; based on the pointing and tracking signal, positioning, and acceleration information, executing the tracking software with a processor of the antenna control unit from a non-transitory computer-readable medium storing the tracking software, with instructions that, when executed by the processor, cause the processor to perform satellite pointing and tracking; identifying a tracked satellite signal upon the tracking software detecting the desired satellite; and generating, using a modulator in the tracking command device, one or more radio-frequency (RF) signals for an interference purpose with respect to the desired satellite that is being tracked.

Example 13 is the method of example 12 that may optionally include that communicating positioning and acceleration information to the tracking software comprises an inertial reference unit (IRU) providing the acceleration information, which is at least about one of a plurality of axes.

Example 14 is the method of example 12 that may optionally include that performing satellite pointing and tracking with the tracking software comprising using two-line-element sets and ephemeris information along with the position information, the acceleration information and heading information including an estimate of a heading of the satellite antenna to perform acquisition and tracking with respect to the desired satellite.

Example 15 is the method of example 12 that may optionally include that the interference purpose comprises interference testing with respect to link between the detected satellite and the satellite antenna.

Example 16 is the method of example 15 that may optionally include that the satellite antenna is an electronically scanned array antenna, and wherein the method further comprises: configuring the electronically scanned array antenna to have a receive sub-array and a transmit sub-array, and further wherein interference testing is performed using communications being sent on the link from the transmit sub-array to the receive sub-array.

Example 17 is the method of example 12 that may optionally include that the interference purpose comprises interference with communications of an existing link associated with the detected satellite using the signal transmitted by the satellite antenna to the detected satellite, and wherein the method further comprises generating the signal having a frequency and polarization that match those being used for communications of the existing link associated with the detected satellite.

Example 18 is the method of example 12 that may optionally include communicating a range in the pointing and tracking signal to improve accuracy of the tracking software.

Example 19 is the method of example 12 that may optionally include communicating satellite information from the ephemeris, obtained via a sensor from an ephemeris database, to the tracking software.

Example 20 is the method of example 12 that may optionally include that the satellite antenna is an electronically scanned array antenna.

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

We claim:

1. An interference testing system comprising:
a satellite antenna including an antenna control unit having a processor and a non-transitory computer-readable medium storing a tracking software with instructions that, when executed by the processor, cause the processor to perform satellite pointing and tracking;
a tracking command device in electronic communication with the tracking software and operable to generate and communicate a signal to the tracking software, the signal including satellite pointing and tracking information to the tracking software; and
a global navigation satellite system (“GNSS”) device in electronic communication with the tracking software and operable to communicate position information to the tracking software, wherein the tracking software is operable to use the pointing and tracking information and position information to scan for and detect satellites and signals communicated therethrough,
wherein the tracking command device includes a modulator to generate one or more radio-frequency (RF) signals for an interference purpose using a detected satellite that is being tracked.

2. The system of claim 1 wherein the satellite antenna is an electronically scanned array antenna.

3. The system of claim 1, further comprising:
an inertial reference unit (IRU) in electronic communication or coupled with the GNSS device, the IRU operable to provide acceleration information at least about one of a plurality of axes.

4. The system of claim 3 wherein the tracking software uses two-line-element sets and ephemeris information along with the position information, the acceleration information and heading information including an estimate of a heading of the satellite antenna to perform acquisition and tracking with respect to one or more of the satellites.

5. The system of claim 1 wherein the interference purpose comprises interference testing with respect to link between the detected satellite and the satellite antenna.

6. The system of claim 5 wherein the satellite antenna is an electronically scanned array antenna that is reconfigurable to have a receive sub-array and a transmit sub-array, and further wherein interference testing is performed using communications being sent on the link from the transmit sub-array to the receive sub-array.

7. The system of claim 1 wherein the interference purpose comprises interference with communications of an existing link associated with the detected satellite using the signal transmitted by the satellite antenna to the detected satellite, the signal having a frequency and polarization that match a signal being used for communications of the existing link associated with the detected satellite.

8. The system of claim 1 wherein the tracking command device includes a vector signal analyzer.

9. The system of claim 1 wherein the tracking command device includes a sensor in electronic communication with an ephemeris database and operable to communicate satellite information from the ephemeris to the tracking software.

10. The system of claim 1 further comprising a sensor or a vector signal analyzer operable to communicate a range in the pointing and tracking information to improve accuracy of the tracking software.

11. The system of claim 1, further comprising:
an amplifier coupled to the satellite antenna.

12. An interference testing method comprising:
communicating satellite pointing and tracking signal to a tracking software of a satellite antenna having an antenna control unit;
communicating positioning and acceleration information to the tracking software;
based on the pointing and tracking signal, positioning, and acceleration information, executing the tracking software with a processor of the antenna control unit from a non-transitory computer-readable medium storing the tracking software, with instructions that, when executed by the processor, cause the processor to perform satellite pointing and tracking;
identifying a tracked satellite signal upon the tracking software detecting the desired satellite; and
generating, using a modulator in the tracking command device, one or more radio-frequency (RF) signals for an interference purpose with respect to the desired satellite that is being tracked.

13. The method of claim 12 wherein communicating positioning and acceleration information to the tracking software comprises an inertial reference unit (IRU) providing the acceleration information, which is at least about one of a plurality of axes.

14. The method of claim 12 wherein performing satellite pointing and tracking with the tracking software comprising using two-line-element sets and ephemeris information along with the position information, the acceleration information and heading information including an estimate of a heading of the satellite antenna to perform acquisition and tracking with respect to the desired satellite.

15. The method of claim 12 wherein the interference purpose comprises interference testing with respect to link between the detected satellite and the satellite antenna.

16. The method of claim 15 wherein the satellite antenna is an electronically scanned array antenna, and wherein the method further comprises: configuring the electronically scanned array antenna to have a receive sub-array and a transmit sub-array, and further wherein interference testing is performed using communications being sent on the link from the transmit sub-array to the receive sub-array.

17. The method of claim 12 wherein the interference purpose comprises interference with communications of an existing link associated with the detected satellite using the signal transmitted by the satellite antenna to the detected satellite, and wherein the method further comprises generating the signal having a frequency and polarization that match those being used for communications of the existing link associated with the detected satellite.

18. The method of claim 12, further comprising:
communicating a range in the pointing and tracking signal to improve accuracy of the tracking software.

19. The method of claim 12 further comprising:
communicating satellite information from the ephemeris, obtained via a sensor from an ephemeris database, to the tracking software.

20. The method of claim 12 wherein the satellite antenna is an electronically scanned array antenna.
